(19) United States
(12) Patent Application Publication
(10) Pub. No.: US 2012/0061516 A1
(43) Pub. Date: Mar. 15, 2012

(54) CURVED PNEUMATIC SUPPORT

(76) Inventors: Joep Breuer, Dubendorf (CH); Rolf Luchsinger, Seegraben (CH)

(21) Appl. No.: 13/201,727

(22) PCT Filed: Feb. 17, 2010
(86) PCT No.: PCT/CH10/00042

§ 371 Date: Nov. 10, 2011

(30) Foreign Application Priority Data
Feb. 17, 2009 (CH) 248/09

(51) Int. Cl. B64C 3/30; E04H 15/20; B23P 11/00

(52) U.S. Cl. 244/123.11; 29/428; 52/2.11

(57) ABSTRACT

The invention relates to a curved pneumatic support comprising an inflatable sleeve which has a web that traverses said sleeve along its length under operating pressure, said web comprising in turn a pressure member and a tension member. The curvature of the support is predefined by the application and is generated as a function of the model of the sleeve and the web.

The present invention relates to an elongated, curved pneumatic support according to the preamble of Claim 1.

Elongated pneumatic supports are known in the prior art. They are characterized by a straight, as a rule cylindrical or spindle-shaped inflatable body, wherein a pressure member runs alongside the body, which pressure member at the face ends is connected to flexible tension members, which in turn are helically wound roundabout the body as is shown for example by WO 01/73245.

By means of this, a equally distributed load vertically acting on the pressure member can then be absorbed; with not evenly distributed load the load-bearing capacity it less.

Such supports have the advantage that relative to their weight they can carry considerable loads (thus, 2 such supports with a weight of approximately 70 kg each and a length of 8 m are able as inflatable bridge to carry a car) and that in the folded-up state they can also be easily transported. In addition, the assembly is extremely simple: thanks to its stiffness the support with its nodes can in principal be simply placed onto the bearing points.

In the mentioned publication it is proposed to join such supports contacting one another side by side into a formation, thus forming a loadable surface, be that a platform or a roof optimally corresponding to the load absorbing capability of the supports.

Additionally it is proposed to design a support in the shape of a torus, so that the pressure bar then forms a circle with at least one node. Regarding the concept, such a support can absorb load radially directed towards its centre. In fact, the convex (i.e. facing the load application) side of the support is suitable for this, but not the concave side, since there the load application comes from a direction for which it is not designed. Thus, such a support can only be employed for the special case of the load acting evenly and constantly all around. If such a support is to be able to absorb load from one direction, nodes resting on a support bearing have to be provided on both sides of the loaded section of the support. Then, the remaining region of the support is not, and thus also not impermissibly loaded, as would be the case without the additional nodes. In other words, the remaining region of the support is then not necessary and can be omitted.

This then presents the case of the WO 2005/007991 discussed below, where a curved support with ends fixed from the outside is discussed, which has a formative framework in the shape of the pressure member clamped in on the abutments in a fixed manner.

Various further developments of such supports deal with improved characteristics for example with regard to the load-bearing characteristics and of the assembly of the supports into a larger unit, such as preferably roofs.

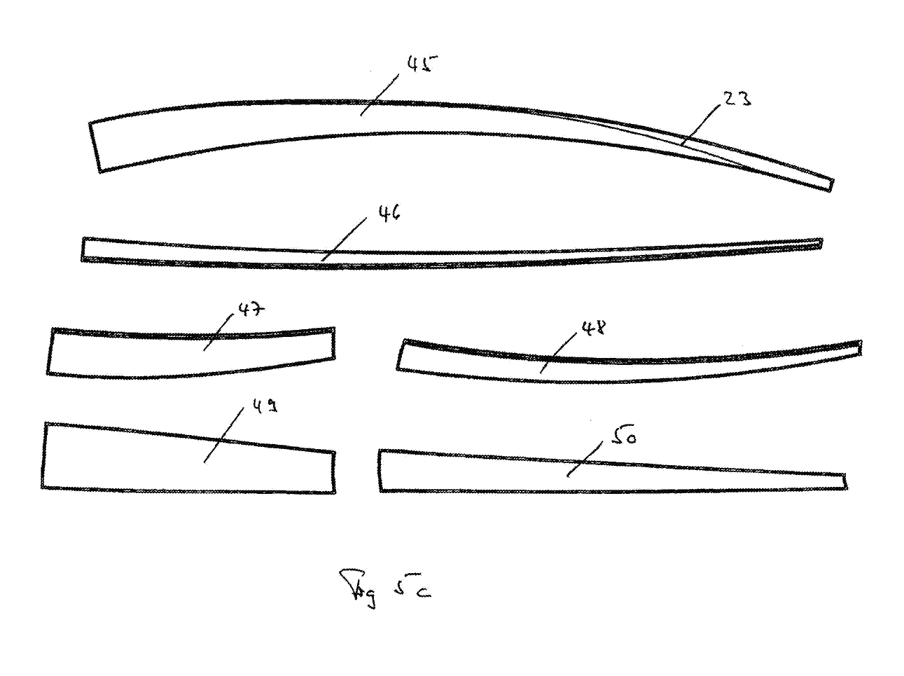

WO 2007/071100 shows a pneumatic support (FIG. 10) curved in the shape of a semi-circle, but which through parallel braces possesses a formative fixed inner framework and is thus “. . . pre-stabilized even without pneumatic hollow bodies”. Thus, the conceptional advantages of pneumatic supports no longer take effect.

In WO 2005/007991 a spindle-shaped pneumatic support is shown with pressure and tension member located opposite, wherein “pressure bar 3 and tension element 4” are located “in the plane of action of the load vector”. In order for this support to also become usable for conversely acting forces, the tension member is reconfigured into a pressure/tension member. In a further exemplary embodiment it is disclosed to provide the support with a plurality of pressure/tension members equally distributed about its circumference, so that loads directed against the support from different directions can be absorbed. Thus, a cage of pressure/tension members corresponding to an intrinsically stable framework is created, which can take load even without pressure in the inflatable body. Additionally shown is a curved support whose ends however have to be fixed from the outside, either through an abutment or through an additional tension element, which fixes the ends independently of the acting load. This support, too, thus comprises a formative framework in the shape of the pressure/tension members, which determines the shape of the support with or without pressure in the body.

In WO 2007/071100 it is attempted to areally expand the support, wherein pressure/tension members connected via webs are arranged into an intrinsically stable framework in the support in the manner of spars and ribs, and wherein the sleeve of the pressure body then corresponds to a clothing of the intrinsically stable framework.

The result is an attractive concept for the formation of pneumatic supports, however with the disadvantage that supports are only suitable for bridges, platforms and roofs, since the load vectors there are located in a vertical plane containing the pressure member and the tension member. For other cases, an intrinsically stable framework has to be provided in the body, so that the conceptional advantages conceivable per se cannot be realised.

Particularly in the region of flying machines there is now a need for supports which relative to the weight are highly loadable. Straight, possibly flat supports, even if these in section have a spindle-shaped etc. contour, are however not very suitable since there are additional requirements particularly in aerofoils:

Increasingly, flying machines such as kites are employed today, wherein the pulling force transmitted through the lines is technically utilised. Thus, for example in the case of ships such as the MS Beluga SkySails, a container cargo ship approximately 140 m in length, which comprises an auxiliary drive in the form of a pulling kite, which in wind strengths of 3 to 8 Beaufort flies at a height of 100 m. Land-based kites can serve for the alternative energy extraction.

It is always an advantage to keep such kites at a certain altitude, which can even be one or several kilometres. Then, the additional irregularities of the wind flow created through the closeness to the ground no longer apply: at a certain altitude this wind flow is substantially more uniform than near the ground. Furthermore, at a certain altitude, the wind velocities are generally higher (and thus also the energy content of the wind). The altitude world record (achieved by a kite chain of 8 chute kites way back in 1919 and still valid for kites today stands at 9740 m.

In the case of a higher flying kite, the importance of kite lines or their cross section, which can restrict the flight altitude that can be achieved, must not be underestimated. Simulation models for example show that with a kite having a span of 8 m (which then perhaps has an area of 11 m²) and lines with a diameter of 1.0 mm a flight altitude of 1 km can only be surpassed with difficulty. At such a flight altitude a line already has a length of approximately 2 km, since the kite obviously cannot stand perpendicularly above the anchorage point. The cross-sectional area of the line accordingly amounts to 2 m². Two such lines, which laterally act on the wing ends of the kite, have a cross-sectional area of 4 m², which only has a braking effect and does not generate any lift.

Two lines are required with kites bent in the shape of a semi-circle in the manner of the paraglider, since on the one hand through the semi-circle the kite surface area is pressed into the circular arc in a stable manner and on the other hand through the pull in one of the lines the kite can be controlled. Similarly for example to the kites used in water sport, which on the edge have an inflatable bead following the semi-circular contour. This bead is put together of straight cylinder sections in the manner of a polygon and ensures the buoyancy of the kite.

Controlling a kite is particularly necessary also for offsetting or for correcting dangerous attitudes caused by local wind disturbances, since some kites due to their design are aerodynamically unstable and thus require control or have to be built in such a manner that they have defined other flight characteristics. If for example control organs are carried in a platform suspended from the kite below the latter, as is the case with the MS Beluga SkySails, the useful power of the kite is reduced. If the control organs as with conventional kites are located on the ground (e.g. in the form of the kite pilot) several lines over the full length, with the disadvantageously large corresponding cross-sectional area are unavoidable.

An aerodynamically stable kite which then is capable of flying safely with only one line has to be provided with a suitably defined areal shape.

Accordingly, it is the object of the present invention to provide a design for the construction of kites with defined flight characteristics such as aerodynamic stability and/or aerodynamic efficiency, but which increases the weight of the flying machines only insignificantly.

This object is solved through a curved pneumatic support with the features of Claim 1 and the method for its manufacture according to Claim 13.

In that the support is at least in sections designed in a curved manner, it can be used for the construction for example of a kite, since in its design it can be adapted to the desired aerodynamic conditions, which imparts the defined flight characteristics to the kite. In that this design is created through the model of the sleeve, the otherwise necessary inner framework elements or formative tension elements (which would then in turn unfavourably influence the force flow in the support) running outside the support are not required. Furthermore, with the curvature, the position of the pressure member can also be determined so that the support according to the invention can absorb irregularly acting load from different directions without material having to be increasingly used or external abutments having to be provided.

In summary, a support is thus available which allows the desired design of a kite without its construction weight being relevantly increased.

It is to be understood that such a support can be used for all purposes, even outside the construction of flying machines, namely there, where a pneumatic support with curvature adaptable to the application and predetermined different load application is desired.

An exemplary embodiment of such a pneumatic support is described in more detail in the following by means of the Figures.

It shows:

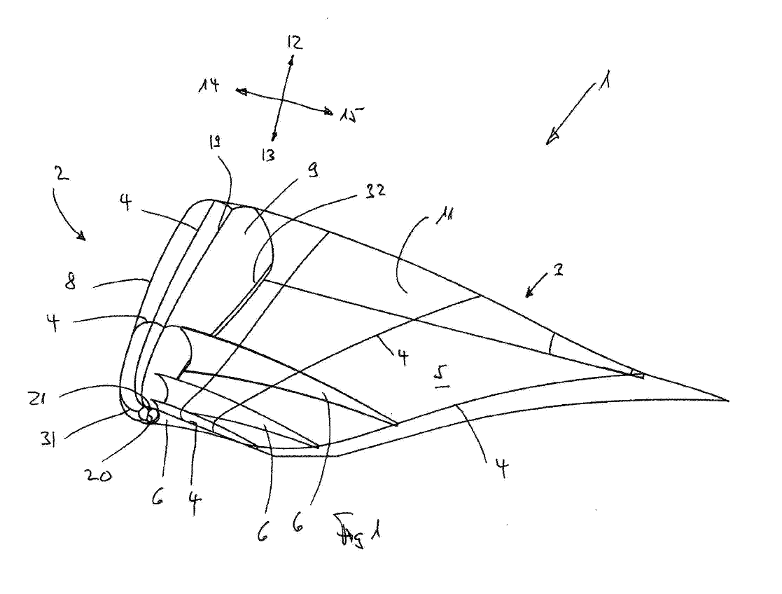

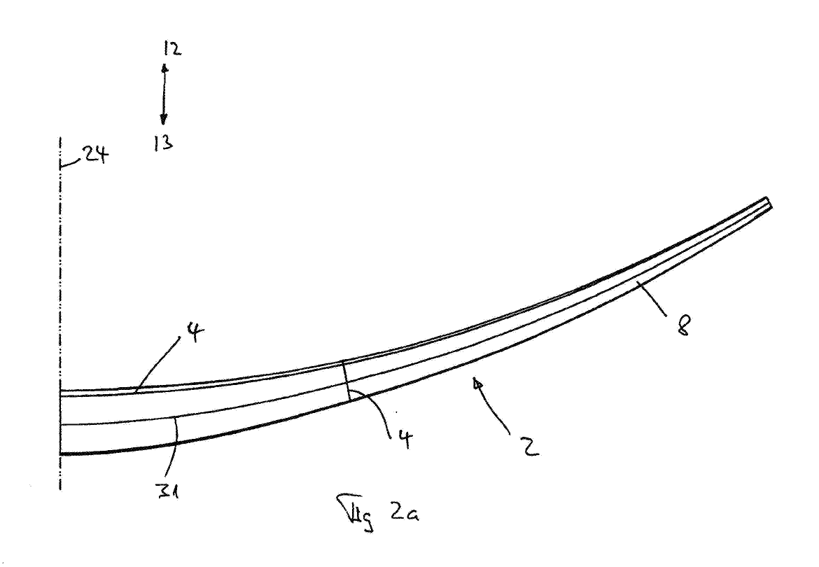

FIG. 1 a view of the structure of a kite consisting of pneumatic supports according to the invention, wherein the one half of the symmetrical structure is shown,

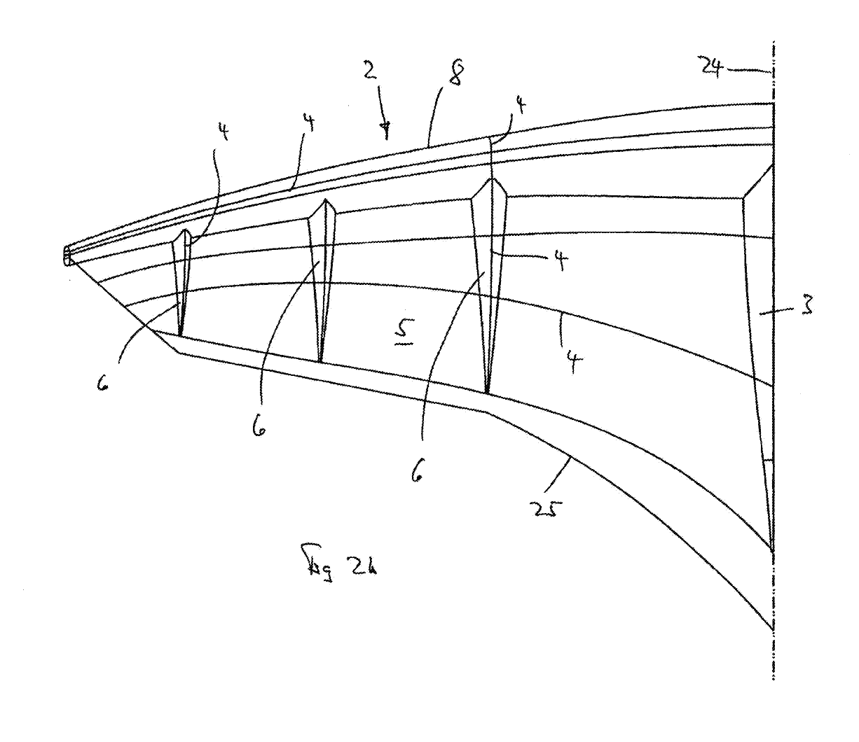

FIGS. 2a and 2b a view from the top and a view from the front of the structure from FIG. 1,

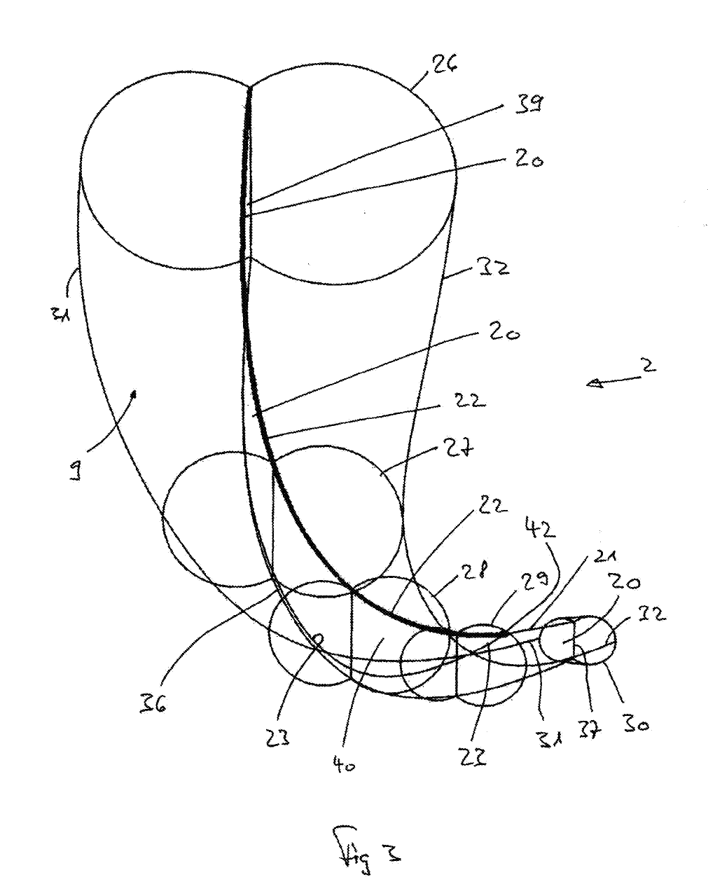

FIG. 3 the spar of the kite with transparently shown sleeve, so that the course of the web is visible, and

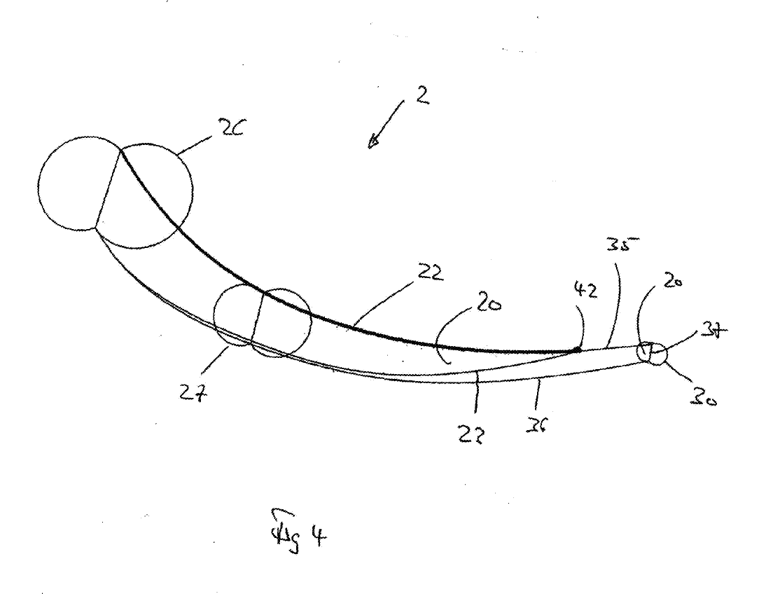

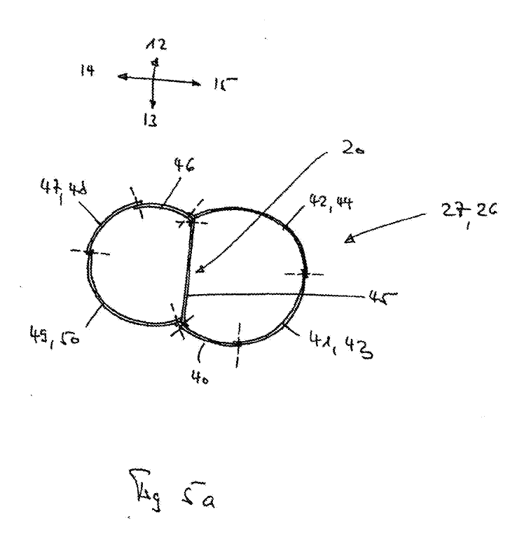

FIG. 4 the arrangement from FIG. 3 in yet a further view, in which the course of the tension member is visible, and

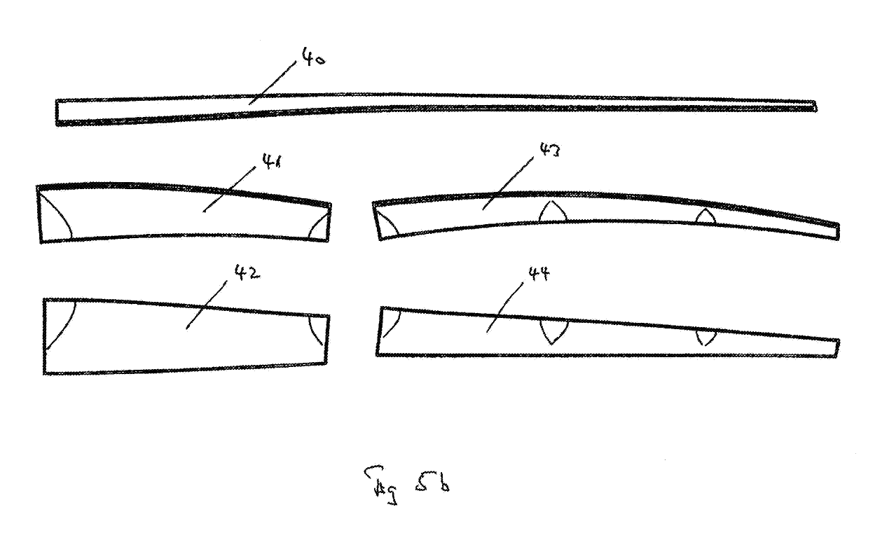

FIG. 5a to c a model of the arrangement from FIG. 1.

In FIG. 1 the structure of the left half of a kite 1 is shown, wherein its right half is designed symmetrically to said left half and is therefore omitted to unburden the Figure. Shown is a support designed as spar 2 which forms the front edge of the kite 1 as well as a longitudinal support 3, which is connected to the spar 2 and defines the area 5 of the kite indicated by the auxiliary lines 4. Further shown are auxiliary supports 6 standing away from the spar 2 towards the rear. The supporting surface 5 can be created through a clothing that is placed over the spar 2, the auxiliary supports 6 and the longitudinal support 3. This can be done in a suitable manner by the person skilled in the art.

Because of the desired flight characteristics, which particularly includes also the aerodynamic stability or aerodynamic efficiency of the kite, the person skilled in the art can determine the shape of the support surface 5 and from that in turn the shape of spar 2, the members 6 and of the longitudinal support 3 resulting from these. In this case, the spar 2 is curved towards the top and also towards the rear, that is curved twice, however such that for the least flow resistance it is always directed forward with its narrowest side 8.

The auxiliary supports 6 are designed on their upper surface corresponding to the desired area 5. Likewise the longitudinal support 3, wherein its upper surface 11 curvature is greater. In addition, the spar 2, the auxiliary supports 6 and the longitudinal support 3 form a framework of individual pneumatic supports that is suitable to carry the clothing of the kite 1.

To explain the directions, the double arrow 12, 13 with the direction 12 towards the top and the direction 13 towards the bottom, as well as the double arrow 14, 15 with the direction 14 towards the front and the direction 15 towards the rear are drawn in.

The spar 2, the longitudinal support 3 and the auxiliary supports 6 are designed as elongated, curved pneumatic supports, each with a substantially inelastic sleeve 9, which is filled with a gas subjected to a slight overpressure (for example an operating pressure of 5 to 10 kPa).

The sleeve 9 consists of a not very elastic, flexible material, preferentially of a fabric which is particularly preferably gas-tight. Alternatively, inflatable bladders of gas-tight material can be placed into the sleeve 9 which as such can be stretchable; the sleeve 9 can then also be designed non-gas-tight. A suitable material is a PU-coated ribstop fabric, such as is common under the trademark ICAREX. The spar 2 is closed on the face end so that it can be put under operating pressure and then assumes the shape represented in the Figures. The represented shape corresponds to the CAD-representation of a kite with 8 m span, which with a lift of approximately 100 kg transmits approximately 100 kg of pull via the line.

The complete flight weight of such a kite amounts to approximately 3 kg.

In the Figure, a constriction 19 is visible in the spar 2 which is caused through the flexible web 20 running in the spar 2, which traverses the spar 2 along its length and is connected to the pressure-loaded walls of the sleeve 9. Under operating pressure, the web 20 is stretched so that the constriction 19 is created. On the in this case upper longitudinal edge 21 of the web 20 runs a pressure member 22 (FIG. 3) as well as in the latter itself a tension member 23 (FIG. 3), wherein these members 22, 23 in conjunction with the web 20 impart the spar 2 increased strength.

Position and course of web 20, pressure member 22 and tension member 23 are determined by the person skilled in the art according to the load application expected in flight, wherein this load application can also include the forces that occur in unintentional attitude of flight. Advantageously, the course of the web 20 and the arrangement of the pressure member 22 and of the tension member 23 is then orientated to the maximum forces, namely such that the majority of these then preferably lie in the plane of the web. The curvature of the spar 2 (and of the other pneumatic supports) is then predetermined with respect to extraordinary load, wherein this curvature however with respect to the normal attitude of flight is not optimal. Thus, under operating load through the loading that occurs, a deformation of the pressure member 22 and of the web 20 results, but which surprisingly has no relevant effect on the mechanical stability of the curved support, in this case the spar 2. If the support or spar 2 (or the longitudinal support 3 as well as the auxiliary supports 6) are to be designed for very high load peaks, tests with regard to the stability are advisable, which can be easily conducted by the person skilled in the art.

With an embodiment for only light loads the tension member 23 as such can be omitted in the web since the connecting point between the web and the pressure-loaded sleeve, as a rule a seam, corresponds to a reinforced point in the web (and can also be carried out suitably reinforced compared with the normal seam). Such a reinforced seam absorbs a minor tensile load and therefore fulfils the function of a tension member 23.

It is likewise possible to reinforce selected wall sections of the inelastic sleeve 9, for example with seams or glued-on material of the type of which the sleeve itself is made. The support can then be exposed in an improved manner to increased load through forces which are not located in the plane of the web. Such reinforcements are preferably provided in combination with a tension member 23.

With a further embodiment the tension member 23 can be replaced with a tension/pressure member (which can then also absorb tension but upon a load from the opposite direction, acts as pressure member). Such a substitution can in principle be carried out in all embodiments of the curved pneumatic support according to the invention.

The arrangement shown in the Figure is an example of a flying apparatus; for any additional applications the pneumatic support can have a different curvature and be designed for another predetermined, general load distribution.

FIGS. 2a and 2b show the structure from FIG. 1, however in a view from the front (FIG. 2a) and in a view from the top (FIG. 2b). The reference numbers designate the same elements as in FIG. 1. Visible is the symmetry plane 24 and the curvature towards the top of the spar 2 (FIG. 2a) and next to the spar 2 the rear termination 25 of the support surface 5 as well as the curvature of the spar 2 towards the rear (FIG. 2b).

FIG. 3 shows the spar 2 from FIG. 1 in a view laterally from the top, slightly offset towards the rear. The outer sleeve 9 of the spar 2 is shown transparently and indicated through auxiliary lines.

The lines 26 to 30 designate various cross sections of the sleeve 9 subjected to operating pressure and thus of the spar 2, from inside to the outside; 26 is the cross section of the spar 2 in the symmetry plane, which divides the spar and the longitudinal support 3 in FIG. 1. 30 is the cross section on the outer end of the spar 2. Additionally shown are auxiliary lines 31 and 32 which run along the sides of the spar 2 from its middle located in the symmetry plane as far as to the outer end of the spar 2.

Finally, the Figure shows the web 20 with its upper longitudinal edge 21, its lower longitudinal edge 36 and its outer end 37. Evident is the curved shape of the web 20, which on the one hand runs towards the top and towards the rear and on the other hand is additionally twisted about its longitudinal axis, thus showing in cross section 26 its surface 39 directed towards the rear and in cross section 28 its surface 40 directed towards the front.

Here, the pressure member 22 extends laterally as far as to the node 42, on which the tension member 23 acts. The region of the spar 2 protruding the node 42 towards the outside is subjected to less load in flight operation and additionally serves as airbag against shocks during the landing of the kite 1. Because of the design of the spar 2 according to the invention, the latter can absorb the high load brought about the operation; the dimensioning of the pressure member 22 adequate for this however is by no means (intentionally because of the optimised light-weight construction) adequate to survive hard shocks during the landing without damage. If such a protection is not desired, the node 42 can be arranged at the end of the pneumatic support, in this case the spar 2.

Surprisingly it has been shown that it is not absolutely necessary to completely arrange the pressure member 22 in the web 20. Depending on the course of the curvature of the support, this can in sections also run somewhat next to its longitudinal edge 35, i.e. outside the web 20 in the sleeve 9, wherein the wall section between the tension member 23 and the web 20 then acts in a stabilising manner, i.e. transmits load in the web 20 to the pressure member 22. The pressure member 22 is then still assigned to the respective longitudinal edge 35 of the web 20 in an operational manner. Likewise, the tension member 23 in sections can run outside the web 20, preferentially in the pressure-loaded wall of the sleeve 9 next to the longitudinal edge 36 (located opposite the longitudinal edge 35) operationally assigned to said longitudinal edge.

FIG. 4 shows the spar 2 from FIG. 1 with the course of the web 20, the pressure member 22 and the tension member 23. Here it becomes clear that the tension member 23 over a large length section of the web 20 runs in the latter and reaches the longitudinal edge 36 only just before the cross section 26. The course of the tension member depends on the predetermined loading of the spar 2 and can—if applicable through tests—be optimised by the person skilled in the art.

With yet a further embodiment of the pneumatic support a plurality of webs can be provided, either running next to one another or traversing the web along its length, or in by sections one after the other in such a manner that the pneumatic support is optimally adapted to the predetermined load case with different size load applications from different direction. Webs running next to one another (with the pressure and tension member assigned in each case) impart the web for example in the same place stability against load application from different direction or allow offsetting an unfavourable curvature of a web (caused through the conditions in another section) in this section through a more favourable curvature of the other web. Webs arranged in sections one after the other can for example be provided if in a straight section of the support pressure loading only occurs in its longitudinal axis(or no loading to speak of at all).

Naturally, not only the spar 2 but all pneumatic supports (according to the embodiment shown in FIG. 1 the longitudinal support 3 and the auxiliary supports 6) can be designed as described above. In particular, pneumatic supports as exemplarily shown in FIG. 1 can be joined into a framework. What is then obtained is not a framework which is arranged and supports a pneumatic support (thus the prior art described at the outset), but a framework composed of pneumatic supports.

A framework node in a framework of pneumatic supports is preferably designed in such a manner that a support at the face end is partially penetrated by a further support running in another direction, as is exemplarily shown in FIG. 1 by means of the auxiliary supports 6 and the spar 2 traversing these at the face end.

Fastening is preferentially effected through sewing of the sleeves abutting one another of the respective pneumatic supports. The pressure member and the tension member of the support that is penetrated can then be suitably fixed on the sleeve with the end abutting the sleeve of the other support, for example through sewing in a pocket arranged on this sleeve. It is also possible to connect the pressure member with the pressure member of the traversing support. Such a framework is surprisingly stiff.

The curved pneumatic support according to the invention can be designed according to a predetermined load as is described in more detail in connection with FIG. 1 and defined in its shape, including the course of the web and of the pressure member and tension member. Via CAD the development of the supports can then be shown in the plane which produces a model for the sleeve, i.e. the body of the support and the associated web. If this model is created and sewn together for producing a support the predetermined curvature of the at least one curved support section is obtained under operating pressure. The slightly bending-elastic pressure member in this case follows this curvature since even at minor operating pressure substantial forces preloading the sleeve and the web are created. Even when using a pre-bent pressure member (which for example is produced from bendable carbon fibre tube) this cannot withstand the preloading forces established through the operating pressure and then assumes the predetermined position. Since the pressure member is to substantially absorb pressure forces, but none or only subordinate bending moments (it is protected against bending on the location of the web through the web and the preloaded sleeve), it can be dimensioned correspondingly weakly, with the advantage that its weight only unsubstantially increases the weight of the pneumatic support but yet substantially increases its load capacity. The same applies when a tension member as described above is replaced with a pressure member. The bending elasticity of the pressure member allows a bending elasticity of the curved pneumatic support, as well as here of the supporting surface 5 of the kite 1, which is necessary for a flying apparatus and can also be favourable or necessary for other applications.

With a preferred embodiment the development is dismantled so that a model of a plurality of individual parts is created, which the person skilled in the art designs to suite production so that the joining in the production is facilitated.

On joining, the course of the web in the pneumatic support is obtained on the one hand by its model and on the other hand by the course of the connecting points with the pressure-loaded walls.

FIGS. 5a, 5b and 5c show the CAD model of the left half of the kite 1 or of its spar 2 shown in FIG. 1. FIG. 5a shows schematically the position of the individual model parts 40 to 50 of the FIGS. 5b and 5c. Shown is a cross section 26, 27 (FIG. 3) with the model parts 40 to 50 sewn together there, wherein a seam location is indicated through the short, interrupted lines. Only three model parts, namely the model part 45 for the web 20 and a model part 46 sewn to said web and directed to the front as well as a model part 40 sewn downwards onto said web and directed towards the rear run over the entire length of the part of the spar 2 shown in FIG. 1. The other model parts 41, 42 and 47, 49 extend from the middle of the spar 2 (i.e. from the symmetry plane 24) towards the outside, wherein then in each case a further model part 43, 44 and 48, 50 follows and extends as far as to the outer end of the spar 2.

The double or triple lines of the model parts 40 to 50 indicate the overlapping regions for the seam locations; the single lines of the locations where the auxiliary supports 6 and the longitudinal support 3 join the spar 2.

1. An elongated curved pneumatic support comprising:
an inflatable, substantially inelastic sleeve comprising a plurality of sleeve components;
a flexible web traversing said inflatable sleeve lengthwise, the flexible web being connected along the longitudinal edges to the pressure-loadable wall of the inflatable sleeve;
an elongated pressure member operably assigned to a longitudinal edge of the flexible web;
wherein the elongated curved pneumatic support under operating pressure is curved, at least by sections, along its length in a predetermined manner;
wherein curvature of at least one support section is defined by a pattern of the plurality of sleeve components and a course of the flexible web in the elongated curved pneumatic support and the a course of a plurality of connecting locations of the flexible web with at least one pressure-loadable wall.

2. The pneumatic support according to claim 1, wherein the flexible web is curved at least in sections, and the curvature preferentially follows a curvature of the elongated curved pneumatic support.

3. The pneumatic support according to claim 1, wherein:
a tension member or a further tension/pressure member is arranged within the flexible web; and which with
at least one end of the tension member is connected to the elongated pressure member in a node.

4. The pneumatic support according to claim 1, wherein the elongated pressure member is operably coupled to a tension member, which, at least in sections, runs outside the flexible web, within a pressure-loaded wall of the inflatable sleeve, next to the longitudinal edge of the flexible web located opposite the elongated pressure member.

5. The pneumatic support according to claim 1, wherein:
the elongated pressure member is operably coupled to a tension member;
the tension member comprises a reinforcement of the pressure-loaded wall;
the reinforcement comprises a reinforcement seam; and
the reinforcement seams is an areal reinforcement section arranged on a wall region.

6. The pneumatic support according to claim 1, wherein the elongated pressure member is connected to the longitudinal edge of the flexible web.

7. The pneumatic support according to claim 1, wherein the flexible web substantially traverses the elongated curved pneumatic support over an entire length.

8. The pneumatic support according to claim 1, wherein said elongated curved pneumatic support tapers along a length of the elongated curved pneumatic support.

9. The pneumatic support according to claim 1, wherein the elongated pressure member and a tension member define a framework of supports.

10. The pneumatic support according to claim 9, wherein:
in a framework node, a first support at a face end is partially penetrated by a second support running in another direction; and
the elongated pressure member and the tension member or tension/pressure member coupled to said elongated pressure member are fixed on the second support independently of one another.

11. The pneumatic support according to claim 10, wherein the elongated pressure member or the tension member is fixed on the pressure-loaded wall of the second support, preferentially in a pocket arranged on a wall of the second support.

12. A flying apparatus comprising a pneumatic support according to claim 1.

13. A method for producing a pneumatic support, the method comprising:
determining, based on a predetermined loading of an elongated curved pneumatic support, a geometrical shape of the elongated curved pneumatic support, the geometrical shape comprising a curvature of the elongated curved pneumatic support, a course of a flexible web, and an arrangement of pressure elements and tension members;
developing an unfolded projection of the elongated curved pneumatic support and the flexible web; and
developing a pattern of components of the unfolded projection which, upon assembly, curves the pneumatic support in a predetermined manner with the flexible web running therein in a predetermined manner.
